(19) United States
(12) Patent Application Publication
(10) Pub. No.: US 2026/0320599 A1
(43) Pub. Date: Oct. 15, 2026

(54) SYSTEMS AND METHODS FOR PROCESSING DATA ACROSS INCOMPATIBLE COMPUTER PLATFORMS

(71) Applicant: PAYPAL, INC., San Jose, CA (US)

(72) Inventors: Han Qiu, Shanghai (CN); Hui Wu, Yixing (CN); Yunqi Zhang, Shanghai (CN); Xuewei Zhang, San Jose, CA (US); Bingnan Xiao, San Jose, CA (US)

(21) Appl. No.: 19/177,380

(22) Filed: Apr. 11, 2025

(51) Int. Cl. G06Q 20/40

(52) U.S. Cl. CPC G06Q 20/401

(57) ABSTRACT

Methods and systems are presented for providing a collaborative computer framework for facilitating processing of data across different incompatible computer environments. Under the collaborative computer framework, different computer platforms associated with different computer environments may collaborate with each other in processing transactions for users of an online service provider. The different computer platforms may exchange data and/or computer instructions with each other. Each computer platform may also execute computer instructions to process local data on behalf of another computer platform such that a computer platform may obtain results from processing data that is not locally accessible by the computer platform.

### BACKGROUND

The present specification generally relates to data processing, and more specifically, to a computer framework for processing data across different computer platforms according to various embodiments of the disclosure.

### Related Art

As computer devices become more widely connected, data is more frequently transferred across devices and processed by computer devices and platforms in heterogeneous environments. Due to the different requirements (e.g., processing requirements, data protection requirements, etc.) from different computer environments, it is a challenge to ensure that the data is properly processed in different computer environments while satisfying the requirements associated with the different computer environments. For example, when a standalone and isolated computer platform is implemented within each of the different computer environments, each computer platform may be capable of processing the data in its local computer environment according to the requirements of the local computer environment. However, the computer platform may not be aware of the requirements associated with the other computer environments, and may not process the data in a manner that would also satisfy the requirements of the other computer environments. In addition, when the data is transferred between the computer environments, a first computer platform of a first computer environment may transfer only a portion of the data to a second computer platform of a second computer environment due to the data protection requirements or other restrictions/limitations associated with the first computer environment, which substantially limits the ability of the second computer platform to process the data. Thus, there is a need for providing a computer framework for facilitating data processing across heterogeneous computer environments.

### BRIEF DESCRIPTION OF THE FIGURES

FIG. 1 is a block diagram illustrating an electronic transaction system according to an embodiment of the present disclosure;

FIG. 2 illustrates operations performed by different computer platforms according to an embodiment of the present disclosure;

FIG. 3 illustrates interactions among different computer platforms for processing an onboarding transaction according to an embodiment of the present disclosure;

FIG. 4 illustrates interactions among different computer platforms for processing a payment transaction according to an embodiment of the present disclosure;

FIG. 5 is a flowchart showing a process of processing an onboarding transaction under a collaborative computer framework according to an embodiment of the present disclosure;

FIG. 6 is a flowchart showing a process of processing a payment transaction under a collaborative computer framework according to an embodiment of the present disclosure; and

FIG. 7 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a collaborative computer framework that facilitates processing of data across heterogeneous computer environments. As discussed herein, different computer environments may be associated with different requirements or limitations/restrictions (e.g., different processing requirements, different data protection requirements, etc.) for storing, transmitting, and processing data. When certain data is processed in different computer environments, it is challenging for the computer platform associated with each of the computer environments to process the data while satisfying the requirements associated with the different computer environments.

In a non-limiting example, a computer system may deploy different computer platforms to process data within different computer environments. The deployment of the different computer platforms may be based on one or more factors, such as geographical locations, computer components (e.g., hardware components, software components, etc.) availability, and other factors. Each of the computer environments may be associated with a different set of requirements or limitations/restrictions for processing data. The requirements associated with each computer environment may include one or more data protection requirements such as a requirement of using a specific strength of encryption algorithm (e.g., a specific encryption level such as a minimum number of bits for an encryption key to encrypt data, etc.) to encrypt certain types of data, or a restriction of transferring certain types of data to a device external to the computer environment, etc., and one or more data processing requirements such as a requirement of using a particular algorithm or logic for processing the data, a requirement of verifying attributes of certain data (e.g., an age of the data, a modification of the data, etc.). Limitations and/or restrictions may include those imposed by the computing system, such as due to system limitations, set forth by entities operating such systems, and other factors. While various contexts described herein refer to requirements, the different embodiments are also suitable for use with limitations and/or restrictions for processing data, not just requirements.

Different computer platforms may be selected to process data based on different factors. For example, when a first entity (e.g., a user or company) registers for an account with the computer system, a first computer platform associated with a first computer environment may be selected to process the registration request for the first entity based on one or more attributes of the first entity (e.g., a location of the first entity, etc.). The first computer platform may obtain entity information (e.g., a name, a birthdate, an address, information associated with a financial account, state of incorporation, etc.) from the first entity, and may generate entity data for the first entity based on the entity information obtained from the first entity. The first computer platform may also store the entity data in its local data storage. In some embodiments, the entity data may be generated and/or stored in a manner that satisfies a first set of requirements associated with the first computer environment. For example, when the first set of requirements includes a requirement to encrypt certain types of data using a particular encryption level (e.g., using a minimum number of bits of encryption key to encrypt the data), the first computer platform may first encrypt at least a portion of the entity data using an encryption algorithm and an encryption key that satisfies the particular encryption level, and store the encrypted data in the data storage.

The entity data may be used by the first computer platform or other computer platforms for processing various transactions associated with the first entity. For example, when the first entity conducts a transaction (e.g., a data access transaction, a fund transfer transaction with a second entity, etc.) via the computer system, a computer platform may be selected to process the transaction based on various attributes associated with the transaction (e.g., a location of the transaction, a location associated with the second entity, etc.). When the first computer platform is selected to process the transaction, the first computer platform may use the entity data stored in the data storage to process the transaction for the first entity. Since the first computer platform has access to all of the entity data associated with the first entity that is stored in the data storage of the first computer platform and a first set of requirements associated with the first computer platform, the first computer platform may process the entity data of the first entity for the transaction in a manner that satisfies the first set of requirements. For example, the first computer platform may use the specific algorithm(s) or logic(s) specified in the first set of requirements to process the entity data for the transaction. The first computer platform may then use the result from processing of the entity data of the first entity to process the transaction.

However, when a second computer platform associated with a second computer environment is selected to process the transaction, the second computer platform may not be able to process the entity data in a manner that satisfies a second set of requirements associated with the second computer environment and the first set of requirements associated with the first computer environment. For example, the second computer platform may not have knowledge of the first set of requirements associated with the first computer environment. In addition, even if the second computer platform has knowledge about the first set of requirements, the second computer platform may not have the ability to read and/or process any or all of the entity data associated with the first entity to process the transaction.

First, the first computer environment may be associated with a data protection requirement that prevents at least a portion of the entity data to be transferred to the second computer platform, such that the second computer platform may not have sufficient information to process the transaction. Second, the first computer platform may have generated the entity data of the first entity using a format that is compatible with the first computer platform and the first computer environment (such that the first computer platform may perform operations on the entity data, such as loading the entity data to the computer memory of the first computer platform, rendering the entity data for display, modifying the entity data, etc.). The format may not be compatible with the second computer platform and the second computer environment. As such, even if the second computer platform can access the entity data, the second computer platform may not be able to process the entity data. Due to the lack of interoperability among the computer platforms and the computer environments, the capability of the computer system to process data across different computer platforms and computer environments may be limited.

As such, according to various embodiments of the disclosure, a collaborative computer framework is provided to facilitate processing of data across heterogeneous computer environments. Under the computer framework, multiple computer platforms, each being deployed within a different computer environment, may work with each other to process data in a collaborative manner, such that the data can be processed in a way to satisfy the requirements associated with the different computer environments. For example, when a first computer platform associated with a first computer environment processes an onboarding (e.g., registration) transaction for the first entity, the first computer platform may process the onboarding transaction in collaboration with a second computer platform, such that the second computer platform may also have information associated with the first entity. In some embodiments, the second computer platform may be associated with a second computer environment that corresponds to a different geographical region from the first computer environment. In some embodiments, when the computer system operates within more than two different computer environments, the second computer platform may facilitate the collaboration among different computer platforms associated with different computer environments. In such an arrangement, the second computer platform may serve as a global platform for facilitating collaboration in processing data and transactions among different platforms, such as ones associated with or dedicated to specific geographic regions.

In particular, when the first entity requests to register an account with the computer system, the first computer platform may first obtain information from the first entity. After verifying the information and generating first entity data for the first entity according to a first format compatible with the first computer platform, the first computer platform may submit a registration request to the second computer platform. The registration request may include at least some of the information obtained from the first entity, but not all. For example, the first computer platform may only provide a first portion of the information obtained from the first entity based on a data protection requirement associated with the first computer environment that restricts transferring of a second portion of the information to devices external to the first computer environment. Based on the first portion of the information, the second computer platform may generate second entity data for the first entity according to a second format compatible with the second computer platform. The second entity data may be generated to be compatible with one or more hardware components of the second computer platform and the second computer environment (e.g., an operating system, a file system, a memory type associated with the second computer platform, etc.). In some embodiments, the second computer platform may also encrypt the second entity data using an encryption level (e.g., an encryption key having a minimum number of bits, etc.) that satisfies a data protection requirement associated with the second computer environment. This way, when the second computer platform is selected to process a transaction associated with the first entity, the second computer platform may process the transaction using the second entity data stored locally within the second computer platform.

In some embodiments, the first computer platform and/or the second computer platform may also store linking information that links the first entity data to the second entity data, such that the first computer platform and the second computer platform may subsequently process data associated with the first entity in a collaborative manner, e.g., sharing data and processing loads. In particular, when the second computer platform is selected to process a transaction associated with the first entity (e.g., a transaction between the first entity and a second entity, etc.), the second computer platform may identify the first entity based on the second entity data stored in the data storage of the second computer platform. The second computer platform may retrieve the second entity data and process the transaction using the second entity data. However, since the second entity data was generated based on only a portion of the information obtained from the first entity, the second entity data may not have sufficient information for the second computer platform to process the transaction (e.g., may have missing data required for processing the transaction) and to satisfy the data processing requirements associated with the second computer environment. For example, in order to process the transaction within the second computer environment, the second computer platform is required to execute one or more algorithms that require certain data that is missing from the second entity data accessible locally by the second computer platform. However, the second computer platform may not be permitted to have access to the missing data due to the data protection requirements associated with the first computer environment.

As such, according to the computer framework disclosed herein, instead of executing the one or more algorithms that require the missing data available or stored locally on the second computer platform, the second computer platform may transmit the one or more algorithms to the first computer platform, and request the first computer platform to execute the one or more algorithms on behalf of the second computer platform based on the first entity data stored locally on the first computer platform. For example, as the second computer platform performs the operations to process the transaction, the second computer platform may suspend the operations when the second computer platform determines that one or more of the operations require the missing data associated with the first entity. The second computer platform may then transmit the one or more algorithms associated with the one or more operations to the first computer platform. The one or more algorithms transmitted to the first computer platform may include a computer-executable program (e.g., binary code), and the first computer platform may simply execute the program and provide the first entity data as input data for the program. However, as discussed herein, since the first computer platform may store the first entity data in the first format that is compatible with the first computer platform, which may not be compatible with the second computer platform (e.g., data may be encrypted using an encryption key that is not known to the second computer platform, data generated that is incompatible with the operating system, file system, computer memory of the second computer platform, etc.), the binary code that is configured to process data in the second format compatible with the second computer platform may not be usable to process the first entity data in the first format. As such, in some embodiments, the second computer platform may transmit pseudocode (e.g., a description of what the one or more algorithms do) to the first computer platform. The pseudocode may be generated in a computer platform-agnostic format, such as JSON, XML, etc.

Upon receiving the pseudocode from the second computer platform, the first computer platform may generate executable binary code that implements the one or more algorithms based on the pseudocode, and execute the binary code. The binary code may access the first entity data that is stored locally on the first computer platform and process the first entity data based on the one or more algorithms. The first computer platform may generate a result from processing the first entity data using the one or more algorithms (e.g., the result may indicate whether the processing is successful or not, etc.), and may return the result to the second computer platform as a response to the request. The second computer platform may then resume the operations of processing the transaction using the result obtained from the first computer platform.

After processing the transaction, the second computer platform may generate transaction data representing the transaction. In some embodiments, the second computer platform may transmit the transaction data to the first computer platform, such that the first computer platform may subsequently use the transaction data to process other transactions locally within the first computer environment (e.g., when the first computer platform is selected to process another transaction associated with the first entity, etc.). By providing the computer framework that enables different computer platforms to communicate and collaborate with each other while processing data for the computer system, data can be processed within heterogenous computer environments in a manner that satisfies the computer processing requirements associated with the different computer environments.

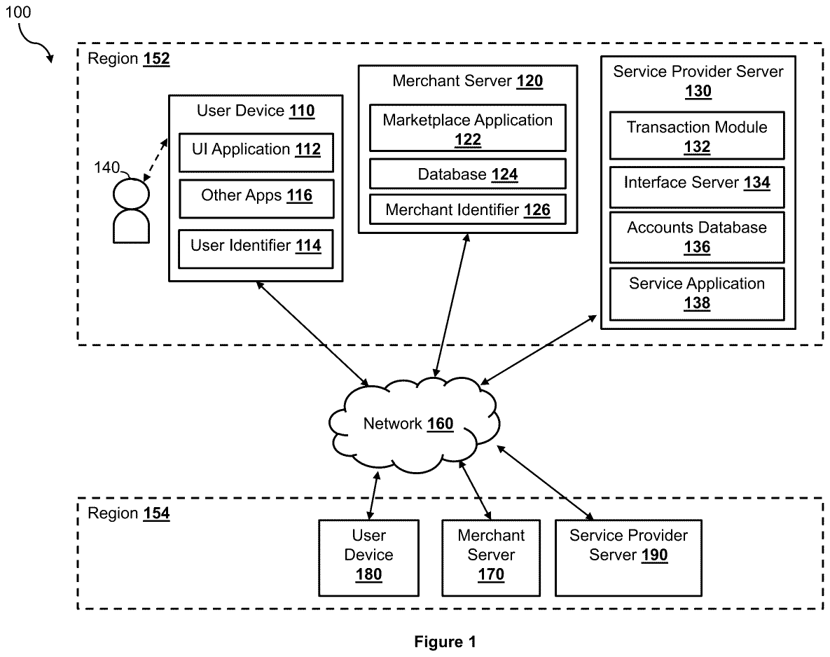

FIG. 1 illustrates an electronic transaction system 100, within which the computer framework may be implemented according to one embodiment of the disclosure. The electronic transaction system 100 includes service provider servers 130 and 190, merchant servers 120 and 170, and user devices 110 and 180, that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant servers 120 and 170, and/or the service provider servers 130 and 190 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, includes other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 is passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding account, to perform an electronic purchase transaction with a merchant associated with the merchant server 120, to provide information associated with the new funding account, to initiate an electronic payment transaction with the service provider server 130, to apply for a financial product through the service provider server 130, to access data associated with the service provider server 130, etc.).

It has been contemplated the user device 180 may include similar components as the user device 110, and may enable another user to perform the same operations with the merchant server 170, and/or the service provider server 190 as described above with respect to the user device 110 and the merchant server 120 and/or the service provider server 130.

The merchant server 120, in various embodiments, is maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items or services, which may be made available to the user device 110 for viewing and purchase by the user.

The merchant server 120, in one embodiment, includes a marketplace application 122, which may be configured to provide information over the network 160 to the user interface application 112 of the user device 110. In one embodiment, the marketplace application 122 includes a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

It has been contemplated that the merchant server 170 includes similar components as the merchant server 120, and may enable another entity (e.g., another merchant, another government agency, another social media platform, etc.) to perform the same operations described above with respect to the merchant server 120 to users via the merchant server 170.

The service provider server 130, in one embodiment, may be maintained by a transaction processing entity or an online service provider, which may provide processing for electronic transactions between users (e.g., the user 140 of user device 110, the user of the user device 180, etc.) and merchants (e.g., the merchant of the merchant server 120, the merchant of the merchant server 170, etc.). As such, the service provider server 130 may include a service application 138, which may be adapted to interact with the user devices 110 and 180 and/or the merchant servers 120 and 170 over the network 160 to facilitate the electronic transactions (e.g., electronic payment transactions, data access transactions, etc.) among consumers and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain a database 136 that stores data associated with the online service provider, such as user data associated various accounts of users with the online service provider, (e.g., the user 140 associated with user device 110, the user associated with the user device 180, the merchant associated with the merchant server 120, the merchant associated with the merchant 170, etc.), transaction data associated transactions conducted between accounts with the online service provider, device data associated with devices used by users to conduct transactions, and various other information collected by the service provider server 130. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. Transaction information may include transaction amounts, dates, times, and/or locations associated with the transactions, transaction types, items being purchased in the transactions, and other information related to the transactions. Device information may include device identifiers (e.g., MAC addresses, etc.), network addresses (e.g., Internet Protocol (IP) addresses, etc.), screen resolutions, operating system information, device manufacturers and models, and other information related to the devices used to conduct the transactions.

In one implementation, a user may have attributes stored with the service provider server 130 that include identify attributes to identify the user and credentials to authenticate or verify the identity of the user with the service provider server 130. User attributes may include personal information, banking information, funding sources, and/or passwords. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements at least a portion of the collaborative computer framework disclosed herein. The transaction processing module 132 may be configured to process transaction requests (e.g., an onboarding transaction request, a login transaction request, a data access transaction request, a payment transaction request, etc.) received from the user devices 110 and 180 and/or the merchant servers 120 and 170 via the interface server 134.

Due to the volume of transactions conducted with the online service provider, and the distribution of users across different geographical regions, the online service provider may deploy multiple service provider servers (e.g., the service provider server 130, the service provider server 190, etc.) for processing different transactions. As such, the service provider server 190 may also include similar components as the service provider server 130, such that the service provider server 190 may perform the same types of operations (e.g., receiving transaction requests from users, processing data and transactions, etc.) as the service provider server 130. For example, the service provider server 190 may also include an interface server, an accounts database, a service application, and a transaction module that are respectively similar to the interface server 134, the accounts database 136, the service application 138, and the transaction module 132 of the service provider server 130.

While the service provider servers 130 and 190 are both configured to process transactions for users of the online service provider, each of the service provider servers 130 and 190 may be operated to provide services for and in a different geographical region. For example, the service provider server 130 may be deployed to service users within a region or computing environment 152, where the user device 110 and the merchant server 120 are located, and the service provider server 190 may be deployed to service users within a region or computing environment 154, where the user device 180 and the merchant server 170 are located. Each of the service provider servers 130 and 190 may also be operated within a different computer environment (e.g., different computer hardware processors, different operating systems, different file systems, etc.).

Based on the different components included within the different computer environments and/or the different corresponding geographical regions, each of the different computer environments 152 and 154 may be associated with a different set of requirements for processing data. For example, a particular computer environment may include a particular file system or hardware processor that requires data to be stored in a particular format. In another example, a particular computer environment may include a particular security vulnerability such that certain types of data are required to be encrypted at a particular encryption level. In yet another example, certain types of data that are generated within a particular geographical region may be restricted from being transferred to a device external to the computer environment. As such, each set of requirements associated with a computer environment may include one or more data protection requirements such as a requirement of using a specific strength of encryption algorithm (e.g., a specific encryption level such as a minimum number of bits for an encryption key to encrypt data, etc.) to encrypt certain types of data, or a restriction of transferring certain types of data to a device external to the computer environment, etc., and one or more data processing requirements such as a requirement of using a particular algorithm or logic for processing the data, a requirement of verifying attributes of certain data (e.g., an age of the data, a modification of the data, etc.). The service provider servers 130 and 190 may be configured to process data (and transactions) for the users in different regions according to the requirements associated with the corresponding computer environments 152 and 154. To achieve this objective, the collaborative computer framework may require the service provider servers 130 and 190 to collaborate with each other in processing data for the online service provider.

While only two service providers 130 and 190 are shown in FIG. 1, it has been contemplated that additional service providers may be deployed within the electronic transaction system 100. For example, the online service provider may deploy additional service providers, each associated with a different computer environment, for servicing users and entities within other geographical regions. In some embodiments, when more than two service providers are deployed for performing services in multiple geographical regions, one of the service providers may be configured to serve as a global service provider server (also referred to as a “global platform”) for facilitating the collaborations among the other service provider servers (also referred to as “local platforms”).

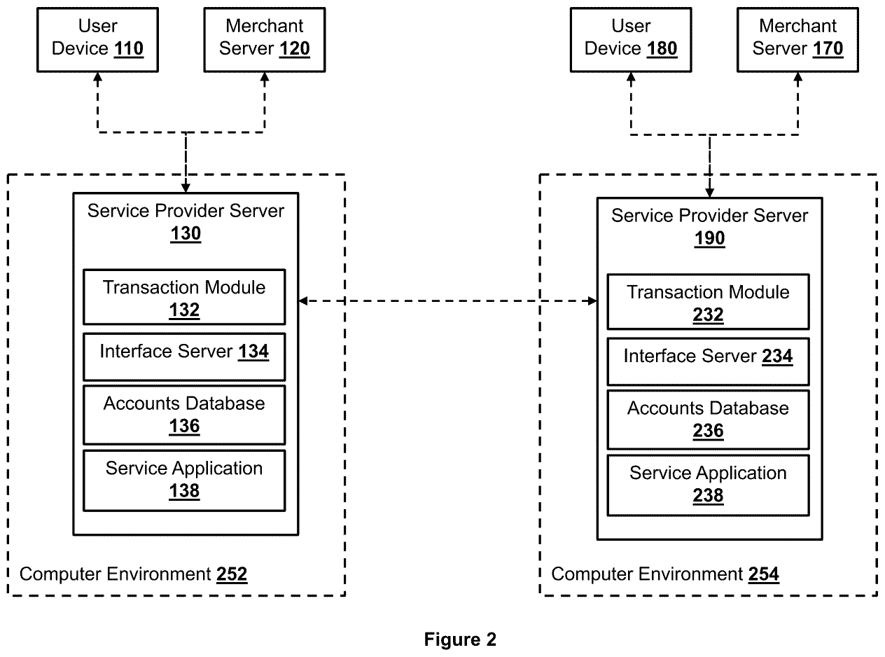

FIG. 2 illustrates operations performed by different service provider servers for processing transactions for the online service provider according to various embodiments of the disclosure. In some embodiments, each of the service provider servers 130 and 190 may include different data processing modules for processing data that satisfies the requirements associated with the corresponding computer environment. For example, the service provider server 130 includes the transaction module 132, the interface server 134, the accounts database 136, and the service application 138, as discussed above by reference to FIG. 1, for processing data and transactions within a computer environment 252. As shown in FIG. 2, the service provider server 190 also includes similar components and modules. For example, the service provider server 190 includes a transaction module 232, an interface server 234, an accounts database 236, and a service application 238 for processing data and transactions within a computer environment 254. The interface server 234 may be similar to the interface server 134 of the service provider server 130, and may provide user interfaces that enables the user of the user device 180 and the merchant of the merchant server 170 to communicate with the service provider server 190. The accounts database 236 may store data associated with various users registered with the online service provider, and transactions conducted with the service provider server 190. The service application 238 may be similar to the service application 138, and may be configured to process payments by resolving electronic transactions through validation, delivery, and settlement. The transaction module 232 may be configured to process transactions among different users and entities according to the requirements associated with the computer environment 254.

The computer environments 252 and 254 may be associated with different sets of requirements for processing data and transactions due to the different components (e.g., computer hardware components, computer software components, etc.) included within the service provider servers 130 and 190, and/or the different geographical regions associated with the different computer environments. For example, the computer environment 252 may require certain types of data (e.g., personal identifiable information, financial information, etc.) to be encrypted in a first encryption level (e.g., a first minimum number of bits required for an encryption key to encrypt the data) while the computer environment 254 may require the data to be encrypted in a second encryption level (e.g., a second minimum number of bits required for an encryption key to encrypt the data) due to the difference in security vulnerabilities inherent in the computer hardware and software components used in the service provider servers 130 and 190. In another example, the computer environment 254 may restrict certain types of data (e.g., financial account data, physical address information, etc.) to be transmitted to devices external to the computer environment 254. In yet another example, the computer environment 252 may require, when processing a transaction, a first set of algorithms to be performed (e.g., for evaluating the user associated with the transaction, for evaluating a risk of the transaction, etc.), while the computer environment 254 may require a second set of algorithms to be performed that is different from the first set of algorithms.

When a request to process a transaction (e.g., an onboarding transaction, a payment transaction, a data access transaction, a login transaction, etc.) with the online service provider is submitted, the request may be routed to one of the service provider servers. In some embodiments, each of the service provider servers 130 and 190 may be implemented within an edge server corresponding to a corresponding geographical region, such that any request submitted from a region is routed to the corresponding service provider server within that region. For example, when the user 140 of the user device 110 uses the UI application 112 to submit an onboarding (e.g., registration) request to the online service provider, the request may be routed to the service provider server 130 since the user device 110 is located within a geographical region associated with the service provider server 130. Upon receiving the request from the user 140, the service provider server 130 may obtain user information from the user 140 via the user device 110. The service provider server 130 may generate user data for the user 140 based on the information obtained from the user 140. In some embodiments, the service provider server 130 may generate the user data in a format that satisfies the requirements associated with the computer environment 252. For example, after generating the user data, the service provider server 130 may encrypt at least a portion of the user data (e.g., certain types of data such as personal identifiable information, health information, financial information, etc.) according to an encryption level specified in the requirements associated with the computer environment 252 before storing the encrypted user data in the accounts database 136. The service provider server 130 may also create an account for the user 140 within the accounts database 136 and associate the user data of the user 140 with the account.

Similarly, when the merchant of the merchant server 120 submits an onboarding request, the request may be routed to the service provider server 130. The service provider server 130 may perform the same or similar operations as discussed above for onboarding an entity associated with the merchant server 120. Whenever a transaction associated with either the user 140 or the merchant of the merchant server 120 is conducted through the service provider server 130, the service provider server 130 may process the transaction and store the transaction data of the transaction in the accounts database 136. The transaction data may also be associated with the parties (e.g., the user 140, the merchant of the merchant server 120, etc.) involved of the transaction, which can be used for processing subsequent transactions involving the same parties.

On the other hand, when the user of the user device 180 submits an onboarding (e.g., registration) request, the request may be routed to the service provider server 190 based on the location of the user device 180. The service provider server 190 may obtain user information from the user of the user device 180. The service provider server 190 may generate user data for the user of the user device 180 based on the information obtained from the user. In some embodiments, the service provider server 190 may generate the user data in a format that satisfies the requirements associated with the computer environment 254. The service provider server 190 may also create an account for the user of the user device 180 and associate the user data of the user with the account.

Similarly, when the merchant of the merchant server 170 submits an onboarding request, the request may be routed to the service provider server 190. The service provider server 190 may perform the same or similar operations as discussed above for onboarding an entity associated with the merchant server 170. Whenever a transaction associated with either the user of the user device 180 or the merchant of the merchant server 170 is conducted through the service provider server 190, the service provider server 190 may process the transaction and store the transaction data. The transaction data may also be associated with the party (e.g., the user of the user device 180, the merchant of the merchant server 170, etc.) involved of the transaction, which can be used to process subsequent transactions involving the same party.

When the users associated with the same geographical region conduct a transaction with the online service provider, the corresponding service provider may use its transaction module to process the transaction for the entities according to the requirements associated with the corresponding computer environment. For example, the user 140 may use the UI application 112 of the user device 110 to purchase items from the merchant associated with the merchant server 120. The user device 110 and/or the merchant server 120 may submit a transaction request to the service provider server 130 for processing the payment between the user 140 and the merchant of the merchant server 120. The service provider server 130 may use the transaction module 132 to process the transaction for the user 140 and the merchant. In order to process the transaction, the transaction module 132 may be required to process different types of data, such as the user data associated with the user 140, the entity data associated with the merchant of the merchant server 120, and transaction data associated with the transaction. For example, the transaction module 132 may evaluate the user 140 using the user data of the user 140 and/or the transaction data associated with transactions previously conducted by the user 140. The transaction module 132 may also evaluate the merchant using the entity data of the merchant and/or the transaction data associated with transactions previously conducted by the merchant.

Since the user data of the user 140, the entity data associated with the merchant of the merchant server 120, and the transaction data associated with transactions previously conducted by the user 140 and/or the merchant are stored locally on or accessible by the service provider server 130 (e.g., the accounts database 136), but not the service provider server 190, the transaction module 132 may access the data from the accounts database 136, and process the data. In some embodiments, the transaction module 132 may process the data according to the requirements associated with the computer environment 252. For example, the transaction module 132 may use one or more algorithms specific to the computer environment 252 to process the data. The transaction module 132 may then process the transaction based on a result from the processing of the data (e.g., authorizing the transaction and using the service application 138 to facilitate the payment, denying the transaction, prompting the user and/or the merchant for additional information, etc.).

However, when the parties involved in the transaction are associated with different geographical regions (e.g., the user 140 using the user device 110 to purchase items from the merchant of the merchant server 170), neither the service provider server 130 nor the service provider server 190, on its own, is capable of processing the transaction according to the requirements associated with the computer environment and the computer environment 254. For example, each of the service provider servers 130 and 190, individually, may not have access to all of the data associated with the user 140 and the merchant of the merchant server 170, since the data of the user 140 and the merchant of the merchant server 170 is separately stored within the service provider server 130 and the service provider server 190, respectively. The data protection requirements of each of the computer environments 252 and 254 may also prevent the service provider server from transmitting the entirety of the data to a service provider server of another computer environment. Furthermore, even if a service provider server has access to the data, the service provider server may not be able to process the data since the data may be generated in a format that is incompatible with the service provider server.

As such, according to the collaborative computer framework disclosed herein, the service provider server 130 and the service provider server 190 may be configured to collaborate with each other to process data (e.g., process transactions), such that the processing of the data can satisfy the requirements associated with both of the computer environments 252 and 254. In some embodiments, the service providers 130 and 190 may collaborate with each other during the processing of different types of transactions, such as onboarding transactions (e.g., registering an account for an entity, etc.), payment transactions (e.g., transferring funds from one account to another account, etc.), funds withdrawal transactions, etc.

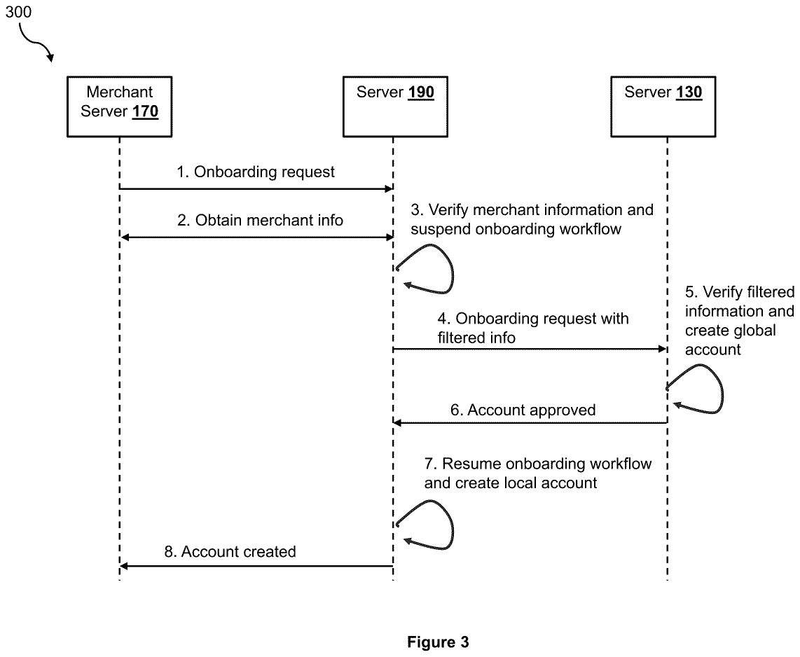

FIG. 3 is a swim lane diagram 300 that shows interactions among different service provider servers for processing an onboarding transaction for an entity according to various embodiments of the disclosure. In this example, a merchant of the merchant server 170 submits an onboarding request to the online service provider (step 1 of FIG. 3). The merchant may submit a request to register for a new account via a website hosted by one of the service provider servers. Based on one or more attributes associated with the merchant (e.g., a location of the merchant server corresponding to the region 154, etc.), the onboarding request may be routed to the service provider server 190. As discussed herein, both of the service provider servers 190 and 130 are involved in the processing of the onboarding transaction. However, since the onboarding request was initially received by the service provider server 190, the service provider server 190 is the primary server for processing the onboarding request, and any other service provider servers (e.g., the service provider server 130, etc.) are the secondary servers for processing the onboarding transaction. The primary server is the server that directly interacts with the device that initiates the transaction request.

Upon receiving the onboarding request, the service provider server 190 may prompt the merchant for information of the merchant (e.g., a name, an address, an email address, funding account information, types of items being sold, etc.) (step 2 of FIG. 3). The service provider server 190 may then process the onboarding transaction for the merchant. First, the service provider server 190 may perform one or more processes based on the information obtained from the merchant (step 3 of FIG. 3). In some embodiments, the service provider server 190 may process the merchant information according to the requirements associated with the computer environment 254. For example, the service provider server 190 may use one or more software modules (e.g., one or more machine learning models, etc.) to execute one or more algorithms based on the merchant information. The one or more algorithms may be related to verifying the information of the merchant, predicting a risk associated with the merchant, determining an authenticity of an identity of the merchant, predicting a sales volume of the merchant, etc.

In some embodiments, the service provider server 190 may determine whether to approve the onboarding request based on the results from processing the merchant information. If the service provider server 190 determines not to approve the onboarding request (e.g., the results indicating a risk of the merchant higher than a threshold, etc.), the service provider server 190 may send a request denial signal to the merchant server 170, indicating that the request for creating an account has been denied. On the other hand, if the service provider server 190 determines to approve the onboarding request (e.g., the results indicating a risk of the merchant below a threshold, etc.), the service provider server 190 may continue to process the onboarding request for the merchant.

The service provider server 190 may generate account data for the merchant based on the information obtained from the merchant and the results from processing the merchant information. In some embodiments, the service provider server 190 may generate the account data in a format that is compatible with the computer environment 254 and according to the requirements associated with the computer environment 254. For example, the service provider server 190 may generate the account data in a format that can be read and processed by the hardware processors within the computer environment 254. The service provider server 190 may also encrypt at least a portion of the account data using an encryption level that satisfies a data protection requirement of the computer environment 254.

In some embodiments, instead of creating the account for the merchant immediately after verifying the information of the merchant, the service provider server 190 may suspend the process of the onboarding request, and may forward the onboarding request the other service provider servers associated with other regions (e.g., the service provider server 130 of the region 152), so that the other service provider server(s) may also process the onboarding request according to the corresponding requirements (step 4 of FIG. 3). In some embodiments, the service provider server 190 may only include, in the onboarding request sent to the other service provider server(s), a portion of the information obtained from the merchant in order to satisfy a data protection requirement associated with the computer environment 254.

Upon receiving the onboarding request sent by the service provider server 190, the service provider server 130 may process the onboarding request according to the requirements associated with the computer environment 252 (step 5 of FIG. 3). For example, the service provider server 130 may use one or more software modules (e.g., one or more machine learning models, etc.) to execute one or more algorithms specific to the computer environment 252 based on the merchant information provided by the service provider server 190. In some embodiments, the one or more algorithms are executed to satisfy the requirements associated with the computer environment 252. However, due to the limited amount of merchant information accessible by the service provider server 130 (the service provider server 190 only provided a portion of the merchant information to the service provider server 130), the service provider server 130 may not be able to complete the processing of the merchant information according to the requirements associated with the computer environment 252.

As such, the service provider server 130 may request the service provider server 190 to perform the tasks according to the requirements associated with the computer environment 252 using the merchant data stored on the service provider server 190 or otherwise available to the service provider server 190 but not available to the service provider server 130. In some embodiments, the service provider server 130 may transmit the one or more software modules to the service provider server 190. However, since the account data generated by the service provider server 190 may not be compatible with the one or more software modules used by the service provider server 130, the service provider server 130 of some embodiments may transmit pseudocode to the service provider server 190. The service provider server 190 may regenerate the software modules within the computer environment 254 based on the pseudocode, and execute the software modules based on the account data stored locally on the service provider server 190. The service provider server 190 may obtain results from executing the software modules, and transmit the results back to the service provider server 130. The service provider server 130 may then finish processing the onboarding transaction based on the results obtained from the service provider server 190. This way, the service provider server 130 may process the merchant data for the onboarding transaction according to the requirements associated with the computer environment 252 without violating the requirements associated with the computer environment 254.

Based on the outcome from processing the merchant data, the service provider server 130 may determine whether to create an account for the merchant. If the service provider server 130 determines not to create an account for the merchant (e.g., the outcome indicating a risk higher than a threshold, etc.), the service provider server 130 may deny the onboarding request, and transmit a request denial back to the service provider server 190. The service provider server 190 may then deny the onboarding request for the merchant and sent a denial to the merchant server 170. It is noted that even though the onboarding request was approved by the service provider server 190 solely based on the processing of the merchant information using the algorithms associated with the computer environment 254, the service provider server 190 may still deny the onboarding request based on the denial of the onboarding request by other service provider servers associated with other computer environments. This way, the onboarding request is approved, and the account is created for the entity, only when all of the requirements associated with all of the computer environments are satisfied.

On the other hand, if the service provider server 130 determines to create an account for the merchant (e.g., the outcome indicating a risk below a threshold, etc.), the service provider server 130 may continue to process the onboarding request for the merchant. The service provider server 130 may generate account data for the merchant based on the information obtained from the service provider server 190 and the results from processing the merchant information. In some embodiments, the service provider server 130 may generate the account data in a format that is compatible with the computer environment 252 and according to the requirements associated with the computer environment 252. For example, the service provider server 130 may generate the account data in a format that can be read by the hardware processors within the computer environment 252. The service provider server 130 may also encrypt at least a portion of the account data using an encryption level that satisfies a data protection requirement of the computer environment 252. The service provider server 130 may then create an account for the merchant within the computer environment 252. For example, the service provider server 130 may create an account identifier for the merchant usable within the computer environment 252, and associate the account data of the merchant with the account identifier. The service provider server 130 may also store the account identifier and the account data in a data storage (e.g., as a new record in the accounts database 136). The service provider server 130 may then transmit an onboarding request approval to the service provider server 190 (step 6 of FIG. 3). The onboarding request approval may be implemented as a webhook event and may include the account identifier created for the merchant by the service provider server 130.

Based on the onboarding request approval received from the service provider server 130, the service provider server 190 may resume the onboarding process for the merchant (step 7 of FIG. 3). For example, the service provider server 190 may create an account for the merchant within the computer environment 254. The service provider server 190 may also create an account identifier for the merchant that is usable within the computer environment 254 (which may be different from the account identifier created within the computer environment 252). The service provider server 190 may store the account identifier and the account data generated by the service provider server 190 in a data storage (e.g., as a new record in the accounts database 236). The service provider server 190 may also link the account identifier generated within the computer environment 252 to the account created within the computer environment 254, such that the service provider server 190 may identify the merchant when it is referenced by computer service providers of other computer environments. In some embodiments, the service provider server 190 may also transmit the account identifier created by the service provider server 190 to the service provider 130. The service provider server 130 may also link the account created within the computer environment 252 to the account identifier, so that a bi-directional link is created for the accounts of the merchant created in both computer environments 252 and 254. By creating an account for an entity only when the request is approved by the different service provider servers 130 and 190, the service provider server 190 ensures that the processing of the onboarding transaction satisfies the requirements associated with the different computer environments 252 and 254.

In some embodiments, the service provider server 130 and/or the service provider server 190 may remove the link between the two accounts of the merchant based on detecting an event. For example, when one of the service provider servers determines to deactivate the account of the merchant (e.g., based on an anomaly of the behavior of the merchant, based on a risk of the merchant exceeding a threshold, etc.), both of the service provider servers may remove the links between the two accounts.

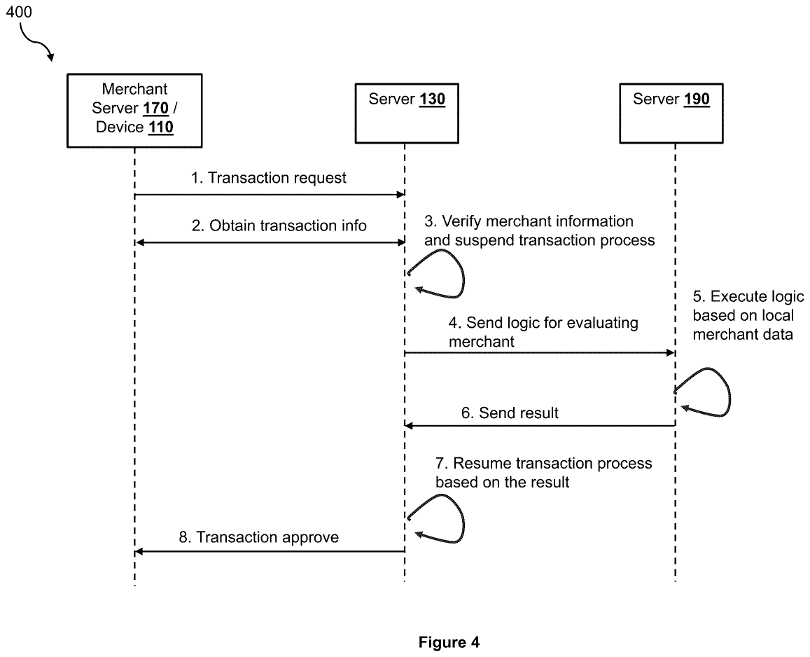

FIG. 4 is a swim lane diagram 400 that shows interactions among different service provider servers for processing a transaction, and specifically a payment transaction, according to various embodiments of the disclosure. In this example, the user 140 of the user device 110 initiates a payment transaction for purchasing one or more items from the merchant of the merchant server 170. For example, the user 140 may use the user device 110 to browse a website hosted by the merchant server 170. The user 140 may initiate the payment transaction with the online service provider via a user interface of the website (step 1 of FIG. 4). Based on one or more attributes of the transaction (e.g., a location of the user device 110 accessing the website, etc.), the transaction request may be routed to the service provider server 130.

Upon receiving the payment transaction request, the service provider server 130 may prompt the user 140 or the merchant server 170 for information of the transaction (e.g., an identity of a payer, an identity of the payee, item being purchased, etc.) (step 2 of FIG. 4). The service provider server 130 may then access account data associated with the parties involved in the transaction (e.g., the user 140 and the merchant of the merchant server 170). In order to process the transaction, the service provider server 130 may be required to process the user data of the user 140 and the merchant data of the merchant server 170 according to the requirements associated with the computer environment 252 (e.g., evaluating a risk of the transaction based on the user 140 and the merchant of the merchant server 170, etc.). As such, the service provider server 130 may access the records from the accounts database 136 based on an account identifier of the user 140 and an account identifier of the merchant of the merchant server 170. Since the service provider server 130 was the primary server for processing the onboarding request for the user 140, the record in the accounts database 136 may include all of the user data associated with the user 140 required for processing the payment transaction.

However, the service provider server 130 may not have access to all of the information associated with the merchant of the merchant server 170, since the service provider server 190 (and not the service provider server 130) was the primary server for processing the onboarding request for the merchant of the merchant server 170. As discussed herein, during the onboarding process, the service provider server 130 was provided only a portion of the merchant information from the service provider server 190. As a result, the service provider server 130 is not capable of processing the transaction based on the limited amount of merchant information accessible locally by the service provider server 130.

Based on the linking information included in the record of the accounts database 136, the service provider server 130 may determine that the account of the merchant within the computer environment 252 is linked to another account of the merchant within the computer environment 254. As such, the service provider server 130 may suspend the processing of the transaction (step 3 of FIG. 4). The service provider server 130 may also request the service provider server 190 to execute the algorithms, on behalf of the service provider server 130, according to the requirements associated with the computer environment 252 based on the merchant data stored in the accounts database 236 (step 4 of FIG. 4). In some embodiments, the service provider server 130 may transmit the one or more software modules (e.g., the one or more machine learning models, etc.) to the service provider server 190. However, since the account data generated by the service provider server 190 may not be compatible with the one or more software modules used by the service provider server 130, the service provider server 130 of some embodiments may transmit pseudocode to the service provider server 190. The service provider server 190 may regenerate the software modules based on the pseudocode, and execute the software modules based on the account data associated with the merchant of the merchant 170 and stored locally on the service provider server 190 or otherwise available to the service provider server 190 but not available to the service provider server 130 (step 5 of FIG. 4). The service provider server 190 may obtain results from executing the software modules, and transmit the results (e.g., as a webhook event, etc.) back to the service provider server 130 (step 6 of FIG. 4).

Upon receiving the results from the service provider server 190, the service provider server 130 may resume the processing of the payment transaction (step 7 of FIG. 4). For example, the service provider server 130 may finish processing the payment transaction based on the results obtained from the service provider server 190. The service provider server 130 may use the user data that is stored locally in the accounts database 136, the transaction data associated with the transaction, and the results received from the service provider server 190 as input values for one or more software modules (e.g., one or more machine learning models) to evaluate the transaction. The one or more software modules maybe configured to classify the transaction based on the input values (e.g., classify the transaction as a legitimate transaction, a fraudulent transaction, etc.). The service provider server 130 may then process the transaction based on the outputs from the one or more software modules (e.g., the classification of the transaction, etc.). This way, the service provider server 130 may process the complete merchant data for the payment transaction according to the requirements associated with the computer environment 254 without violating the requirements (e.g., the data protection requirements) associated with the computer environment 252.

In some embodiments, the service provider server 190 may also request the service provider server 130 to execute one or more algorithms for verifying information associated with the transaction (e.g., verifying that the merchant is not selling items that are restricted based on a policy of the account of the merchant within the computer environment 254, etc.). The service provider server 130 may execute the algorithms using the techniques described herein, and provide verification data (e.g., results from executing the algorithms) back to the service provider server 190.

Based on the outcome from processing the data (e.g., the user data associated with the user 140, the merchant data associated with the merchant of the merchant server 170, the transaction data, etc.), the service provider server 130 may determine whether to approve the payment transaction. If the service provider server 130 determines not to approve the payment transaction, (e.g., the outcome indicating a risk of the transaction higher than a threshold, etc.), the service provider server 130 may deny the payment transaction request, and transmit a request denial to the merchant server 170 and/or the user device 110.

On the other hand, if the service provider server 130 determines to approve the payment transaction (e.g., the outcome indicating a risk below a threshold, etc.), the service provider server 130 may use the service application 138 to settle the payment between the financial account of the user 140 and the financial account associated with the merchant of the merchant server 170. The service provider server 130 may transmit a transaction approval signal to the merchant server 170 and/or the user device 110 (step 8 of FIG. 4). The service provider server 130 may also generate transaction data for the transaction based on the processing of the transaction, and store the transaction data in the accounts database 136. In some embodiments, the service provider server 130 may also transmit at least a portion of the transaction data to the service provider server 190, such that the service provider server 190 may store the transaction data as a transaction record in the accounts database 236, which may be used by the service provider server 190 to process subsequent transactions associated with the merchant of the merchant server 170.

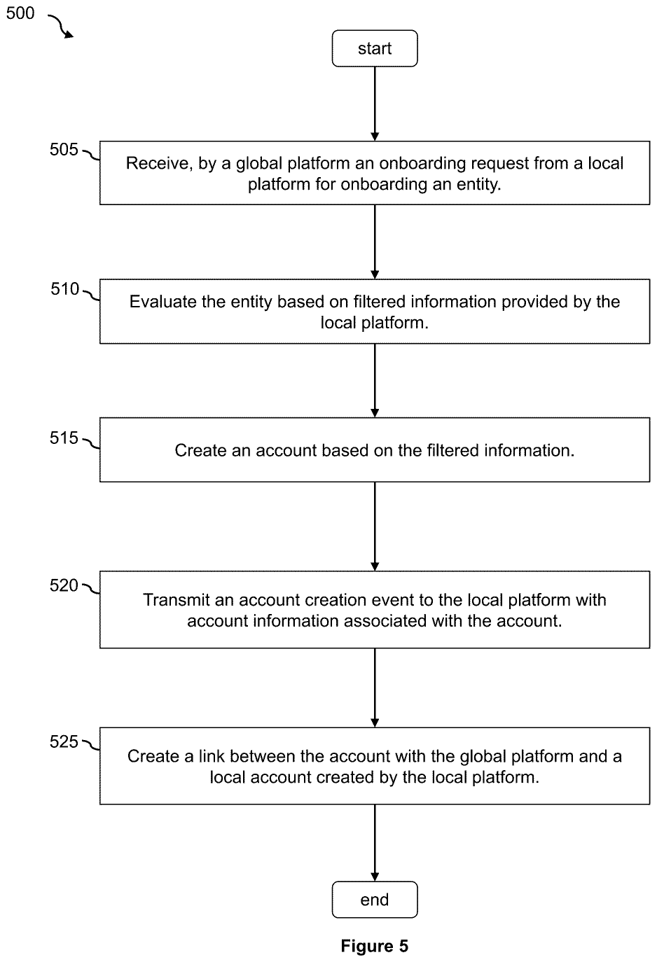

FIG. 5 illustrates a process 500 for processing an onboarding transaction according to various embodiments of the disclosure. In some embodiments, at least a portion of the process 500 may be performed by the transaction module 132 of the service provider server 130 and/or the transaction module 232 of the service provider server 190. The process 500 begins by receiving (at step 505), by a first (e.g., “global”) platform, an onboarding request from a local platform for onboarding an entity. In some embodiments, the service provider server 130 may serve as a global platform for facilitating transactions among second (e.g., “local”) platforms (e.g., the service provider server 190 or other service provider servers corresponding to different local regions, etc.). As an entity (e.g., the user of the user device 180, the merchant of the merchant server 170, etc.) requests to create an account with the online service provider, the request may be initially routed to the service provider server 190. During the processing of the onboarding request, the service provider server 190 may forward the onboarding request to the service provider server 130, so that the onboarding request can be processed (e.g., evaluated) according to the requirements associated with different computer environments 252 and 254. In some embodiments, the service provider server 190 may transmit only a portion of the merchant information that the service provider server 190 obtains from the merchant.

The global platform may evaluate (at step 510) the entity based on filtered information provided by the local platform and create (at step 515) an account based on the filtered information. For example, the service provider server 190 may evaluate the merchant based on the portion of the merchant information provided by the service provider server 190. The service provider server 130 may execute one or more algorithms to evaluate the entity based on the portion of the merchant information. Since the service provider server 130 does not have all of the merchant information, the service provider server 130 may also request the service provider server 190 to execute some of the algorithms, on behalf of the service provider server 130, using the merchant data stored on the service provider server 190. Based on the results of executing the algorithms, the service provider server 130 may create an account for the merchant within the computer environment 252.

After creating the account for the entity, the global platform transmits (at step 520) an account creation event to the local platform with account information associated with the account. For example, the service provider server 130 may transmit an onboarding approval signal to the service provider server 190. The service provider server 130 may also transmit an account identifier of the account created for the merchant within the computer environment 252 to the service provider server 190, such that the service provider server 190 may create a link between an account of the merchant within the computer environment 254 and the account of the merchant within the computer environment 252. In some embodiments, the service provider server 190 may also transmit an account identifier of an account that the service provider server 190 created for the merchant within the computer environment 254 to the service provider server 130.

The global platform then creates (at step 525) a link between the account with the global platform and a local account created by the local platform. For example, based on the account identifier provided by the service provider server 190, the service provider server 130 may create a link between the account created for the merchant by the service provider server 130 within the computer environment 252 and the account created for the merchant by the service provider server 190 within the computer environment 254.

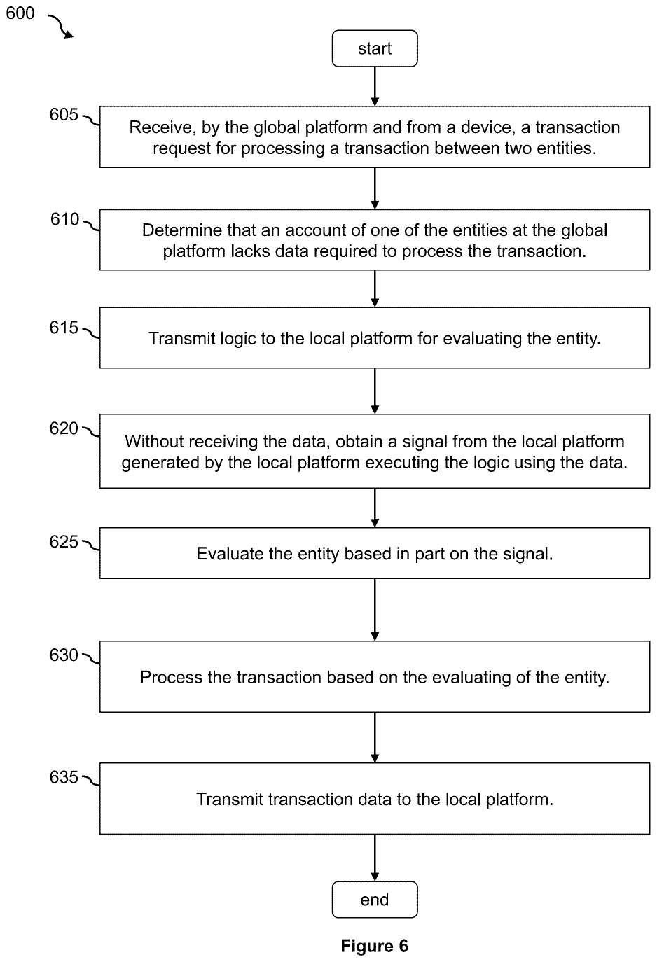

FIG. 6 illustrates a process 600 for processing a payment transaction according to various embodiments of the disclosure. In some embodiments, at least a portion of the process 600 may be performed by the transaction module 132 of the service provider server 130 and/or the transaction module 232 of the service provider server 190. The process 600 begins by receiving (at step 605), by the global platform and from a device, a transaction request for processing a transaction between two entities. For example, the user 140 may initiate a payment transaction request via an interface provided by the merchant of the merchant server 170. The payment transaction request may be associated with a purchase of an item from the merchant, and may be routed to the service provider server 130.

The global platform then determines (at step 610) that an account of one of the entities at the global platform lacks data required to process the transaction and transmits (at step 615) logic to the local platform for evaluating the entity. For example, after identifying the parties involved in the transaction, the service provider server 130 may use the data associated with the parties (e.g., user data associated with the user 140 and merchant data associated with the merchant of the merchant server 170) to process the transaction. The service provider server may execute one or more algorithms (e.g., using one or more software modules) to evaluate the user and the merchant in the process of processing the transaction. However, since the merchant data stored on the service provider server 130 only includes a portion of the merchant information obtained by the service provider server 190, the service provider server 130 may determine that the portion of the merchant information lacks data that is required to perform one or more processes for evaluating the merchant. The service provider server 130 may then transmit a request to the service provider server 190 for executing the algorithms using the merchant information accessible by the service provider server 190.

Without receiving the missing data, the global platform then obtains (at step 620) a signal from the local platform generated by the local platform executing the logic using the data. For example, the service provider server 190 may obtain results from executing the algorithms using the merchant information accessible by the service provider server 190. The service provider server 190 may provide the results to the service provider server 130.

The global platform then evaluates (at step 625) the entity based in part on the signal and processes (at step 630) the transaction based on the evaluating of the entity. For example, the service provider server 130 may use the results provided by the service provider server 190 to perform the processes of evaluating the merchant. As such, the merchant information is evaluated using the algorithms according to the requirements of the computer environment 252 without requiring the service provider server 130 to access any of the missing data. The service provider server 130 may then process the transaction based on the evaluation of the merchant and the user 140.

After processing the transaction, the global platform transmits (at step 635) transaction data to the local platform. For example, after processing the transaction, the service provider server 130 may generate transaction data. The service provider server 130 may store the transaction data in the accounts database. The service provider server 130 may also transmit at least a portion of the transaction data to the service provider server 190, such that the service provider server 190 may store the transaction data and use it to evaluate the merchant in subsequent transactions conducted by the merchant. In some embodiments, a portion of the transaction data is excluded from being transmitted to the service provider server 130 according to the data protection requirements associated with the computer environment 252.

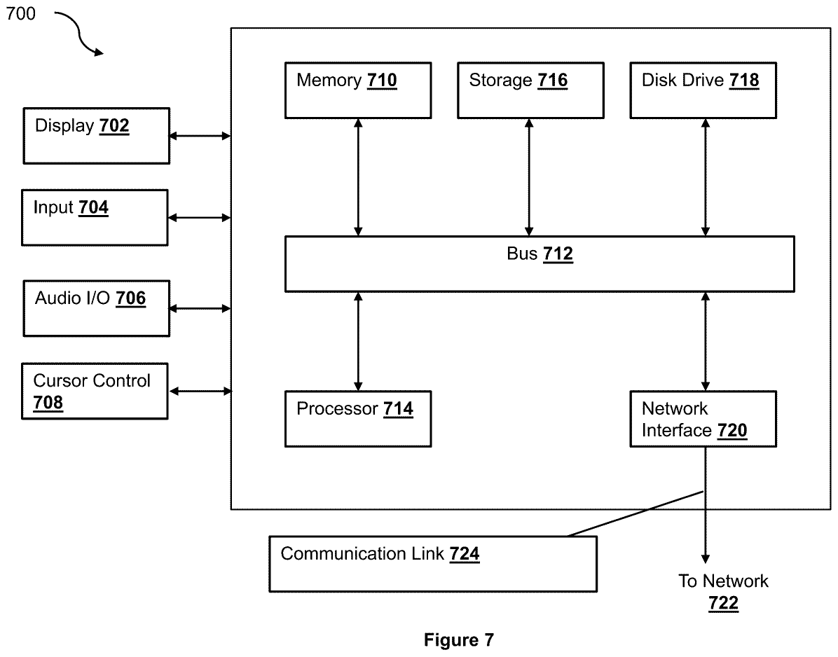

FIG. 7 is a block diagram of a computer system 700 suitable for implementing one or more embodiments of the present disclosure, including the service provider servers 130 and 190, the merchant servers 120 and 170, and the user devices 110 and 180. In various implementations, each of the user devices 110 and 180 may include a mobile cellular phone, personal computer (PC), laptop, wearable computing device, etc. adapted for wireless communication, and each of the service provider servers 130 and 190, and the merchant servers 120 and 170 may include a network computing device, such as a server. Thus, it should be appreciated that the devices 110, 120, 130, 170, 180, and 190 may be implemented as the computer system 700 in a manner as follows.

The computer system 700 includes a bus 712 or other communication mechanism for communicating information data, signals, and information between various components of the computer system 700. The components include an input/output (I/O) component 704 that processes a user (i.e., sender, recipient, service provider) action, such as selecting keys from a keypad/keyboard, selecting one or more buttons or links, etc., and sends a corresponding signal to the bus 712. The I/O component 704 may also include an output component, such as a display 702 and a cursor control 708 (such as a keyboard, keypad, mouse, etc.). The display 702 may be configured to present a login page for logging into a user account or a checkout page for purchasing an item from a merchant. An optional audio input/output component 706 may also be included to allow a user to use voice for inputting information by converting audio signals. The audio I/O component 706 may allow the user to hear audio. A transceiver or network interface 720 transmits and receives signals between the computer system 700 and other devices, such as another user device, a merchant server, or a service provider server via a network 722. In one embodiment, the transmission is wireless, although other transmission mediums and methods may also be suitable. A processor 714, which can be a micro-controller, digital signal processor (DSP), or other processing component, processes these various signals, such as for display on the computer system 700 or transmission to other devices via a communication link 724. The processor 714 may also control transmission of information, such as cookies or IP addresses, to other devices.

The components of the computer system 700 also include a system memory component 710 (e.g., RAM), a static storage component 716 (e.g., ROM), and/or a disk drive 718 (e.g., a solid-state drive, a hard drive). The computer system 700 performs specific operations by the processor 714 and other components by executing one or more sequences of instructions contained in the system memory component 710. For example, the processor 714 can perform the transaction processing functionalities described herein, for example, according to the processes 500 and 600.

Logic may be encoded in a computer readable medium, which may refer to any medium that participates in providing instructions to the processor 714 for execution. Such a medium may take many forms, including but not limited to, non-volatile media, volatile media, and transmission media. In various implementations, non-volatile media includes optical or magnetic disks, volatile media includes dynamic memory, such as the system memory component 710, and transmission media includes coaxial cables, copper wire, and fiber optics, including wires that comprise the bus 712. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 700. In various other embodiments of the present disclosure, a plurality of computer systems 700 coupled by the communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

1. A system comprising:
a non-transitory memory; and
one or more hardware processors coupled with the non-transitory memory and configured to execute instructions from the non-transitory memory to cause the system to:
receive, by a first data processing platform associated with a first computer environment, a request to process a transaction between a first account and a second account;
determine, by the first data processing platform, that (i) the second account lacks data required for processing the transaction and (ii) the second account is associated with a second computer environment that is incompatible with the first computer environment;
transmit, from the first data processing platform to a second data processing platform associated with the second computer environment, instructions associated with a computer logic for processing the data;
without receiving the data from the second data processing platform, receive, by the first data processing platform and from the second data processing platform, a signal indicating a processing of the data based on the second data processing platform executing the instructions; and
process the transaction between the first account and the second account based on the signal.

2. The system of claim 1, wherein executing the instructions further causes the system to:
generate transaction data based on processing the transaction between the first account and the second account;
receive, from the second data processing platform, second instructions for processing the transaction data;
generate, by the first data processing platform, processed data based on executing the second instructions; and
without transmitting the transaction data to the second processing platform, send the processed data from the first data processing platform to the second data processing platform.

3. The system of claim 1, wherein the first data processing platform and the second data processing platform are associated with different geographical regions.

4. The system of claim 1, wherein the first data processing platform is associated with a first web domain, and wherein the second data processing platform is associated with a second web domain.

5. The system of claim 1, wherein the second account is associated with an entity, and wherein executing the instructions further causes the system to:
receive, from the second data processing platform, a request for onboarding the entity, wherein the request comprises entity data associated with the entity, wherein the entity data lacks the data required for processing the transaction; and
generate account data for the second account within the first data processing platform for onboarding the entity based on the entity data.

6. The system of claim 5, wherein executing the instructions further causes the system to:
subsequent to generating the second account, transmit an account creation webhook event to the second data processing platform.

7. The system of claim 6, wherein transmitting the account creation webhook event enables the second data processing platform to create an entity object associated with the entity and store the entity object in the second data processing platform.

8-14. (canceled)

15. A non-transitory machine-readable medium having stored thereon machine readable-instructions executable to cause a first data processing server associated with a first computer environment to perform operations comprising:
receiving a request to process a transaction between a first entity and a second entity;
determining that the first data processing server lacks data for processing the transaction;
determining that the second entity is linked to an account with a second data processing server that is associated with a second computer environment different from the first computer environment;
transmitting, to a second data processing server, instructions associated with a computer logic for processing the data;
without receiving the data from the second data processing server, receiving a result from the second data processing server executing the instructions based on the data accessible by the second data processing server; and
processing the transaction between the first entity and the second entity based on the result.

16. The non-transitory machine-readable medium of claim 15, wherein the operations further comprise:
generating transaction data based on processing the transaction between the first entity and the second entity;
receiving, from the second data processing server, second instructions for verifying the transaction data;
generating verification data based on executing the second instructions using the transaction data; and
without transmitting the transaction data to the second processing platform, sending the verification data from the first data processing server to the second data processing server.

17. The non-transitory machine-readable medium of claim 15, wherein the first data processing server and the second data processing server are associated with different geographical regions.

18. The non-transitory machine-readable medium of claim 15, wherein the first data processing server is associated with a first web domain, and wherein the second data processing server is associated with a second web domain.

19. The non-transitory machine-readable medium of claim 1, wherein the operations further comprise:
receiving, from the second data processing server, a request for onboarding the second entity, wherein the request comprises entity data associated with the second entity, and wherein the entity data lacks the data required for processing the transaction; and
generating account data for onboarding the second entity within the first computer environment based on the entity data.

20. The non-transitory machine-readable medium of claim 19, wherein the operations further comprise:
subsequent to generating the account data, transmitting an account creation webhook event to the second data processing server.

21. A method comprising:
receiving, by a first data processing platform associated with a first computer environment, a request to process a transaction between a first account and a second account;
determining, by the first data processing platform, that (i) the second account lacks data required for processing the transaction and (ii) the second account is associated with a second computer environment that is incompatible with the first computer environment;
transmitting, from the first data processing platform to a second data processing platform associated with the second computer environment, instructions associated with a computer logic for processing the data;
without receiving the data from the second data processing platform, receiving, by the first data processing platform and from the second data processing platform, a signal indicating a processing of the data based on the second data processing platform executing the instructions;
processing, by the first data processing platform, the transaction between the first account and the second account based on the signal.

22. The method of claim 21, further comprising:
generating transaction data based on the processing the transaction between the first account and the second account;
receiving, from the second data processing platform, second instructions for processing the transaction data;
generating, by the first data processing platform, processed data based on executing the second instructions; and
without transmitting the transaction data to the second processing platform, sending the processed data from the first data processing platform to the second data processing platform.

23. The method of claim 21, wherein the first data processing platform and the second data processing platform are associated with different geographical regions.

24. The method of claim 21, wherein the first data processing platform is associated with a first web domain, and wherein the second data processing platform is associated with a second web domain.

25. The method of claim 21, wherein the second account is associated with an entity, and wherein the method further comprises:
receiving, from the second data processing platform, a request for onboarding the entity, wherein the request comprises entity data associated with the entity, wherein the entity data lacks the data required for processing the transaction; and
generating account data for the second account within the first data processing platform for onboarding the entity based on the entity data.

26. The method of claim 25, further comprising:
subsequent to generating the second account, transmitting an account creation event to the second data processing platform.

27. The method of claim 26, wherein the transmitting the account creation webhook event enables the second data processing platform to create an entity object associated with the entity and store the entity object in the second data processing platform.
